(19) United States
(12) Patent Application Publication
(10) Pub. No.: US 2018/0191047 A1
(43) Pub. Date: Jul. 5, 2018

(54) STRUCTURE WITH INTEGRATED METALLIC WAVEGUIDE

(71) Applicant: INVENSAS BONDING TECHNOLOGIES, INC., San Jose, CA (US)

(72) Inventors: Shaowu Huang, Sunnyvale, CA (US); Javier A. DeLaCruz, San Jose, CA (US); Belgacem Haba, Saratoga, CA (US)

(21) Appl. No.: 15/395,197

(22) Filed: Dec. 30, 2016

(51) Int. Cl. H01P 3/16; H01P 11/00

(52) U.S. Cl. CPC H01P 3/16; H01P 11/006

(57) ABSTRACT

A structure can include a first element and a carrier bonded to the first element along an interface. A waveguide can be defined at least in part along the interface between the first element and the carrier. The waveguide can comprise an effectively closed metallic channel and a dielectric material within the effectively closed metallic channel, as viewed from a side cross-section of the structure. Various millimeter-wave or sub-terahertz components or circuit structures can also be created based on the waveguide structures disclosed herein.

### BACKGROUND

### Field

The field relates to structures with integrated waveguides, and in particular, to interconnects and circuit structures with integrated metallic waveguides.

### Description of the Related Art

In some electronic systems, multiple integrated device dies may be mounted to a carrier and may communicate with one another in a variety of ways. For example, in some systems, two integrated device dies can communicate with one another by way of conductive traces or interconnects provided in an intervening package substrate such as a printed circuit board (PCB) or in a silicon interposer. In other systems, a silicon bridge or other interconnect structure can serve to electrically connect two dies within a package or system. However, existing die-to-die interconnects may experience high losses due to conductor loss, crosstalk or other factors. Accordingly, there remains a continuing need for improved die-to-die communications.

### BRIEF DESCRIPTION OF THE DRAWINGS

FIG. 1 is a schematic side sectional view of a structure that includes integrated waveguides, according to some embodiments.

FIG. 2 is schematic perspective view of a waveguide according to various embodiments.

FIG. 3A is a schematic perspective view of a structure with an integrated waveguide, according to various embodiments.

FIG. 3B is a schematic side cross-sectional view of a first waveguide portion disposed between integrated device dies and a carrier.

FIG. 3C is a schematic side cross-sectional view a second waveguide portion disposed along and under a gap between the integrated device dies.

FIG. 4A is a schematic perspective view of a waveguide with metallic features that comprise continuous segments, prior to bonding.

FIG. 4B is a schematic perspective view of a waveguide in which portions of conductive features are patterned with discontinuities or gaps to avoid dishing.

FIG. 4C is a schematic perspective view of a waveguide in which both conductive features are patterned with discontinuities or gaps along their lengths to avoid dishing.

FIG. 5 is a schematic perspective view of a structure with a waveguide embedded in a carrier comprising a semiconductor element, prior to bonding of the dies to the carrier.

FIG. 6 is a schematic side view of a structure comprising a bridge between two dies that includes an integrated waveguide therein.

FIG. 7A is a top plan view of a power divider that incorporates any of the waveguides described herein.

FIG. 7B is a top plan view of a coupler that incorporates the waveguides described herein.

FIG. 7C is a top plan view of a circulator that incorporates the waveguides described herein.

FIG. 7D is a top plan view of a filter that incorporates the waveguides disclosed herein.

FIG. 8 is a schematic system diagram of an electronic system incorporating one or more structures, according to various embodiments.

### DETAILED DESCRIPTION

Various embodiments disclosed herein relate to interconnects and structures with integrated waveguides, e.g., integrated conductive or metallic waveguides. As explained above, existing techniques for providing die-to-die (or chip-to-chip) communications within a package or system may not provide adequate performance at high frequencies. For example, some die-to-die interconnects may experience high current densities which can lead to high losses due to conductor loss, crosstalk and other factors. Moreover, in some systems, it may be difficult to provide millimeter wave or sub-terahertz communications over a range of tens of gigahertz to hundreds of gigahertz (e.g., in a range of 10 GHz to 950 GHz, in a range of 20 GHz to 900 GHz) using coplanar or microstrip waveguides since such devices may be lossy at millimeter-sized wavelengths. The embodiments disclosed herein beneficially enable the use of lower loss metallic waveguides for die-to-die communications, including communications at wavelengths in a range of 0.1 mm to 10 mm.

A metallic or conductive waveguide can comprise an effectively closed metallic or conductive channel as viewed from a side cross-section taken perpendicular to a propagation direction of the waveguide, and can include a low loss dielectric material within the effectively closed channel. In various embodiments, the metallic or conductive waveguide can comprise a metal, including metallic compounds. In some embodiments, the metallic waveguide can be defined by bonding two elements (e.g., two semiconductor elements) along an interface, with the waveguide defined at least in part by the interface. In some embodiments, the two elements can be directly bonded to one another without an intervening adhesive. In other embodiments, the metallic waveguide can be at least partially (e.g., completely) embedded in an element and can include one or a plurality of ports that can receive a radiating element for coupling electromagnetic waves to the waveguide. The disclosed embodiments can therefore provide die-to-die communications with low loss and with little or no crosstalk, which can enable high frequency die-to-die communications. Moreover, in embodiments that utilize direct bonding, the resulting structure can be constructed at lower costs than other techniques, since the waveguides can be constructed using the bonding layers defined for directly bonding two elements to one another. The integrated waveguides disclosed herein can also advantageously reduce the number of radio frequency (RF) components provided in the package, since the waveguides described herein can be directly integrated into the dies and/or other elements.

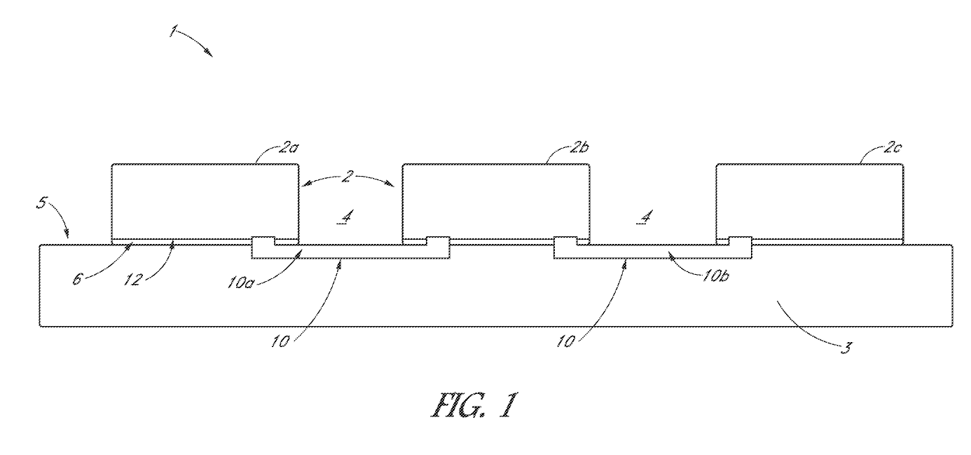

FIG. 1 is a schematic side sectional view of a structure 1 that includes an integrated waveguide 10 (e.g., an integrated metallic or otherwise conductive waveguide), according to some embodiments. The structure 1 can include a plurality of elements 2 mounted to another element, e.g., a carrier 3. For example, in FIG. 1, the elements 2 can comprise a first integrated device die 2a, a second integrated device die 2b, and a third integrated device die 2c, each of which are electrically and mechanically connected to the carrier 3. In various embodiments, the device dies 2a-2c can comprise processor dies, memory dies, sensor dies, communications dies, microelectromechanical systems (MEMS) dies, or any other suitable type of device. The carrier 3 may be any suitable type of element, such as an integrated device die, an interposer, a reconstituted die or wafer, etc. As explained herein, the elements 2a-2c are shown as being mounted to the carrier 3 by way of a direct bond, but in other embodiments, the elements can be connected to the carrier in other ways. In the illustrated embodiment, the elements 2a-2c and the carrier 3 comprise semiconductor elements (e.g., integrated device dies 2a-2c, a semiconductor interposer, etc.), but in other embodiments, the elements and/or the carrier can comprise other types of elements that may or may not comprise a semiconductor material, such as various types of optical devices (e.g., lenses, filters, etc.). As shown, the dies 2a-2c can be laterally spaced from one another along the carrier 3.

In the illustrated embodiment, one or more of the device dies 2a-2c are directly bonded to the carrier 3 without an intervening adhesive. The direct bond between the dies 2a-2c and the carrier 3 can include a direct bond between corresponding conductive features of the dies 2a-2c (e.g., a processor die) and the carrier 3 (e.g., an integrated device die, an interposer, etc.) without an intervening adhesive, without being limited thereto. In some embodiments, the conductive features may be surrounded by non-conductive field regions. To accomplish the direct bonding, in some embodiments, respective bonding surfaces of the conductive features and the non-conductive field regions can be prepared for bonding. Preparation can include provision of a nonconductive layer, such as silicon oxide or silicon nitride, with exposed conductive features, such as metal bond pads or contacts. The bonding surfaces of at least the non-conductive field regions, or both the conductive and non-conductive regions, can be polished to a very high degree of smoothness (e.g., less than 20 nm surface roughness, or more particularly, less than 5 nm surface roughness). In some embodiments, the surfaces to be bonded may be terminated with a suitable species and activated prior to bonding. For example, in some embodiments, the non-conductive surfaces (e.g., field regions) of the bonding layer to be bonded, such as silicon oxide material, may be very slightly etched for activation and exposed to a nitrogen-containing solution and terminated with a nitrogen-containing species. As one example, the surfaces to be bonded (e.g., field regions) may be exposed to an ammonia dip after a very slight etch, and/or a nitrogen-containing plasma (with or without a separate etch). In a direct bond interconnect (DBI) process, nonconductive features of the dies and the carrier can directly bond to one another, even at room temperature and without the application of external pressure, while the conductive features of the dies and the carrier layer can also directly bond to one another, without any intervening adhesive layers. Bonding by DBI forms stronger bonds than Van der Waals bonding, including significant covalent bonding between the surfaces of interest. Subsequent annealing can further strengthen bonds, particularly between conductive features of the bonding interfaces.

In some embodiments, the respective conductive features can be flush with the exterior surfaces (e.g., the field regions) of the dies and the carrier. In other embodiments, the conductive features may extend above the exterior surfaces. In still other embodiments, the conductive features of one or both of the dies and the carrier are recessed relative to the exterior surfaces (e.g., nonconductive field regions) of the dies and the carrier. For example, the conductive features can be recessed relative to the field regions by less than 20 nm, e.g., less than 10 nm.

Once the respective surfaces are prepared, the nonconductive field regions (such as silicon oxide) of the dies 2a-2c can be brought into contact with corresponding nonconductive regions of the carrier 3. The interaction of the activated surfaces can cause the nonconductive regions of the dies 2a-2c to directly bond with the corresponding nonconductive regions of the carrier 3 without an intervening adhesive, without application of external pressure, without application of voltage, and at room temperature. In various embodiments, the bonding forces of the nonconductive regions can include covalent bonds that are greater than Van der Waals bonds and exert significant forces between the conductive features. Prior to any heat treatment, the bonding energy of the dielectric-dielectric surface can be in a range from 150-300 mJ/m², which can increase to 1500-4000 mJ/m² after a period of heat treatment. Regardless of whether the conductive features are flush with the nonconductive regions, recessed or protrude, direct bonding of the nonconductive regions can facilitate direct metal-to-metal bonding between the conductive features. In various embodiments, the dies 2a-2c and the carrier 3 may be heated after bonding at least the nonconductive regions. As noted above, such heat treatment can strengthen the bonds between the nonconductive regions, between the conductive features, and/or between opposing conductive and non-conductive regions. In embodiments where one or both of the conductive features are recessed, there may be an initial gap between the conductive features of the dies 2a-2c and the carrier 3, and heating after initially bonding the nonconductive regions can expand the conductive elements to close the gap. Regardless of whether there was an initial gap, heating can generate or increase pressure between the conductive elements of the opposing parts, aid bonding of the conductive features and form a direct electrical and mechanical connection.

Additional details of the direct bonding processes used in conjunction with each of the disclosed embodiments may be found throughout U.S. Pat. Nos. 7,126,212; 8,153,505; 7,622,324; 7,602,070; 8,163,373; 8,389,378; and 8,735,219, and throughout U.S. Patent Application Nos. 14/835,379; 62/278,354; 62/303,930; and 15/137,930, the contents of each of which are hereby incorporated by reference herein in their entirety and for all purposes.

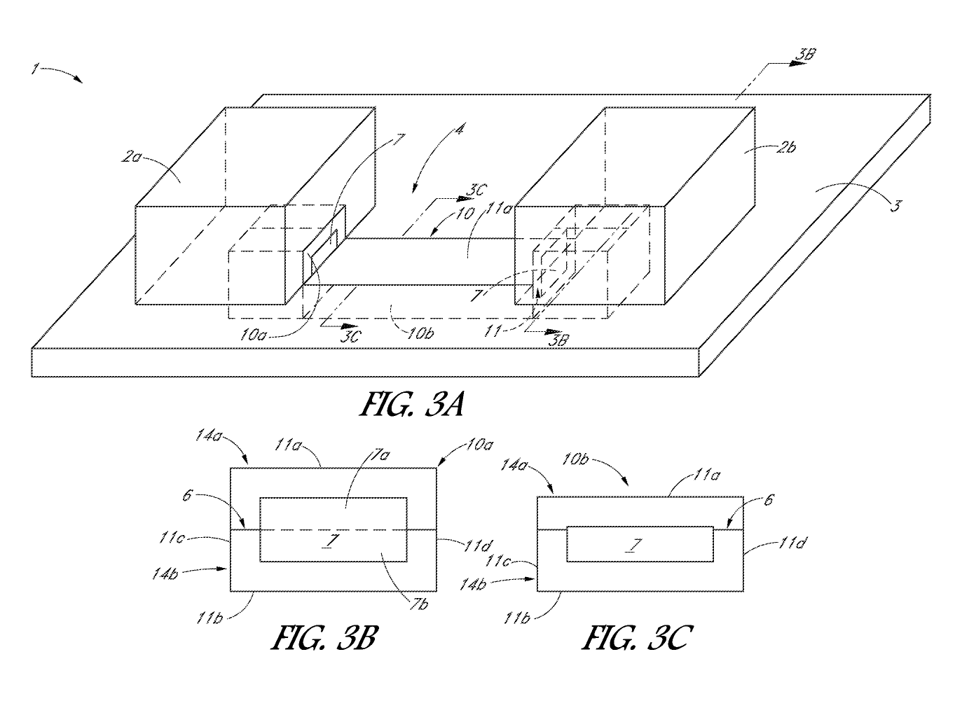

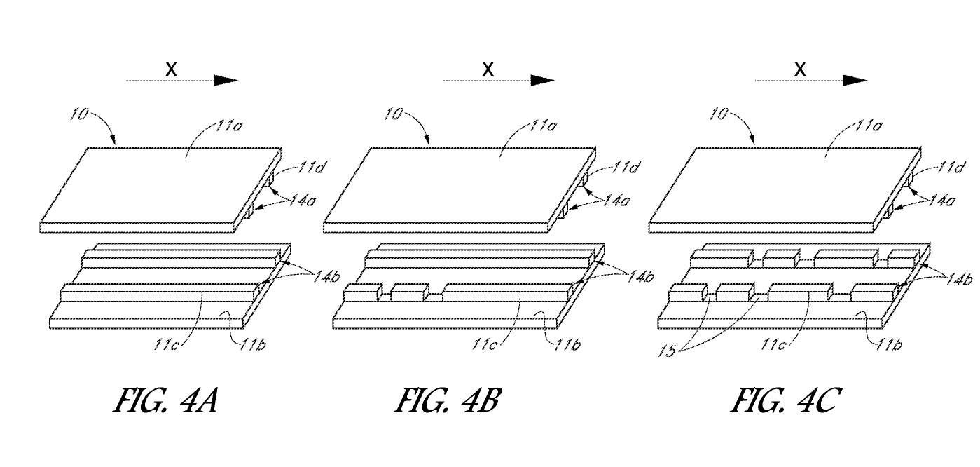

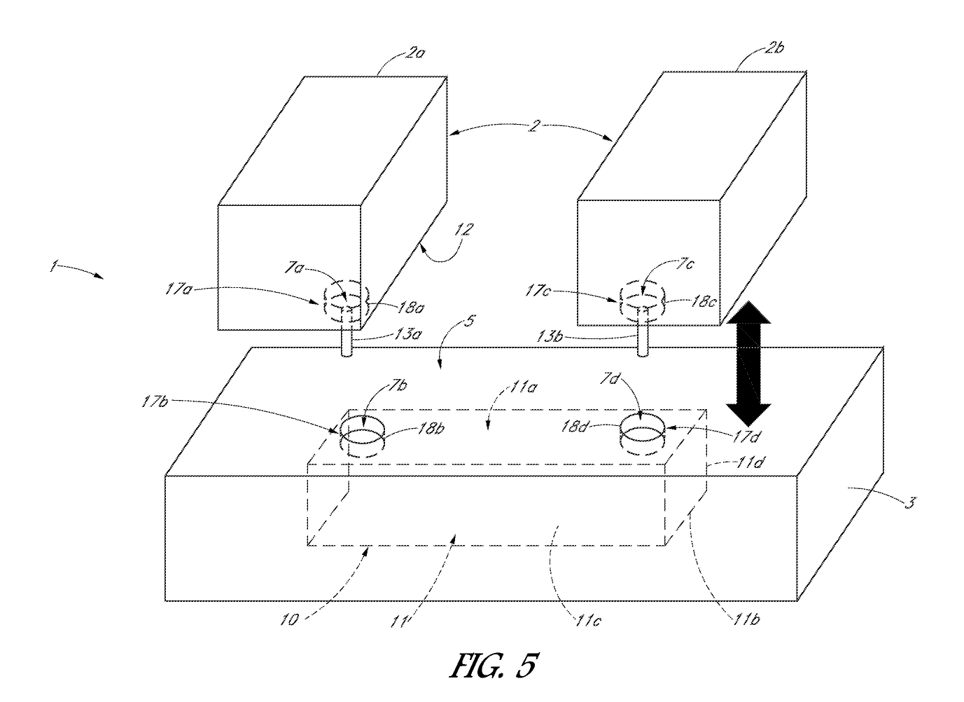

Direct bonding of the dies 2a-2c to the carrier 3 can result in a bond interface 6 between the elements 2 and the carrier 3. The waveguide 10 can be defined along the interface 6 between the carrier 3 and the elements 2 (the dies 2a-2c). For example, as explained herein, the waveguide 10 can comprise a first waveguide portion 10a that is defined by features at the respective lower surfaces 12 of the elements 2 and at an upper surface 5 of the carrier 3. As explained below in connection with FIGS. 3A-4C, metallic and/or dielectric features exposed on the lower surfaces 12 of the dies 2a-2c (the elements 2) can cooperate with corresponding metallic and/or dielectric features exposed on the upper surface 5 of the carrier 3 to define the first waveguide portion 10a of the waveguide 10. The waveguide 10 can also comprise a second waveguide portion 10b disposed along gaps 4 between the integrated device dies 2a-2c. The second waveguide portion 10b can be embedded in the carrier 3 and can be defined by a metallic channel at or near the upper surface 5. The waveguide 10 can enable die-to-die communications between the first die 2a and the second die 2b, and between the second die 2b and the third die 2c. Although three dies 2a-2c are illustrated in FIG. 1, it should be appreciated that any suitable number of dies may be provided and may communicate with one another. Moreover, as explained above, the integrated waveguide 10 disclosed herein can be used in conjunction with any suitable type of element. In addition, although the dies 2a-2c are directly bonded to the carrier 3 without an intervening adhesive in the illustrated embodiment, in other embodiments, the dies 2a-2c can be bonded to the carrier 3 in other ways, such as by way of a conductive adhesive, solder, etc.

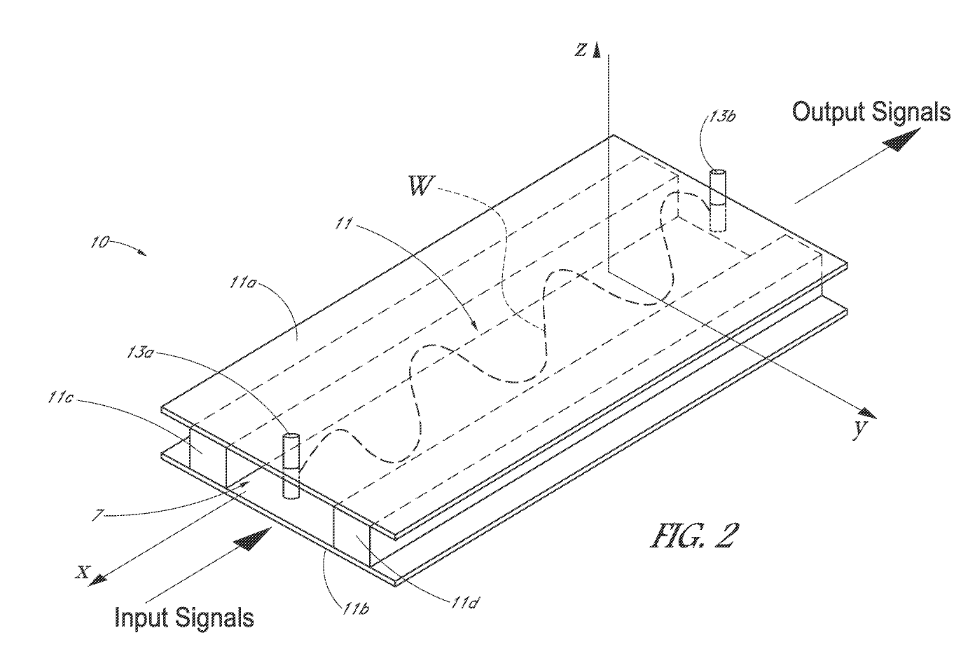

FIG. 2 is schematic perspective view of a portion of the waveguide 10 according to various embodiments. The waveguide 10 shown in FIG. 2 is a metallic waveguide that has a polygonal, and particularly rectangular, cross-section. For example, the waveguide 10 can comprise a channel 11 defined by a plurality of metallic walls 11a-11d that cooperate to delimit an effectively closed cross-sectional profile, as viewed along a cross-section taken transverse to the propagation direction (i.e., the x-axis). A dielectric material 7 can be disposed within the effectively closed metallic channel 11. In FIG. 2, the side section of the channel 11 is completely closed such that the walls 11a-11d define a continuous, closed boundary about the dielectric material 7. As explained below, however, in some embodiments, the effectively closed metallic channel 11 may have gaps or spaces in portions of some of the walls 11a-11d. In various embodiments, the metallic walls 11a-11d of the channel 11 can comprise copper or other metal materials. The dielectric material 7 can comprise any suitable dielectric, such as silicon oxide.

The walls 11a-11d can be electrically grounded so as to provide a bounded pathway along which electromagnetic waves can propagate. As shown in FIG. 2, input signals or waves W can enter at a first end of the waveguide 10 and can propagate parallel to the x-axis and can exit as an output signal at another end of the waveguide 10. In various embodiments, radiating elements 13a, 13b can be provided at both ends of the waveguide 10 to transmit and/or receive electromagnetic waves W along the waveguide 10. In various embodiments the width of the waveguide 10 along the y-direction can define the cutoff frequency for the propagating mode. During operation, a first radiating element 13a can radiate signals or waves W at frequencies that can propagate along the waveguide 10. In some embodiments, the radiating elements 13a, 13b can comprise conductive segments or probes inserted into the dielectric material 7 within the channel 11. Skilled artisans will understand that electromagnetic waves can be coupled to the waveguide 10 in other suitable ways. For example, in some embodiments, the radiating elements 13a, 13b can comprise a conductive loop with the plane of the loop perpendicular to the lines of magnetic force, a linear conductor or probe that is parallel to the lines of electric force, or an aperture in a side wall of the waveguide 10 disposed along the direction of the lines of magnetic force on the side wall. The signals or waves W can propagate along the waveguide 10 and can be received by another radiating element 13b which can convert the waves W to an electrical current. Beneficially, as explained herein, the waveguide 10 can be integrated or embedded in an element (such as an interposer or integrated device die), or at the bond interface 6 between two elements (e.g., at the interface 6 between the dies 2a-2c and the carrier 3). Moreover, in the illustrated embodiment, the waveguide 10 is straight or generally linear as it extends between two dies. However, in other embodiments, any of the waveguides 10 disclosed herein may bend, curve, or otherwise change directions so as to guide the waves to any desirable location in the structure 1.

FIG. 3A is a schematic perspective view of a structure 1 with an integrated waveguide 10, according to various embodiments. FIG. 3B is a schematic side cross-sectional view of the first waveguide portion 10a disposed at interfaces 6 between the dies 2a, 2b and the carrier 3. FIG. 3C is a schematic side cross-sectional view of the second waveguide portion 10b disposed along and under the gap 4 between the dies 2a, 2b. As explained above, in some embodiments, the waveguide 10 can include the first waveguide portion 10a defined at the interfaces 6 between the dies 2a-2b and the carrier 3, as shown in FIG. 3B. In FIG. 3B, the first waveguide portion 10a can be defined by first metallic features 14a and first dielectric features 7a formed in and/or on the respective integrated device dies 2a, 2b, and second metallic features 14b and second dielectric features 7b formed in and/or on the carrier 3.

The first waveguide portion 10a can be formed in any suitable manner, such as by damascene processes. In the arrangement illustrated in FIG. 3B, for example, trenches or recesses can be defined in the lower surfaces 12, which may be the active surfaces, of the dies 2a-2b and in the upper surface 5 of the carrier 3. A metallic layer can be deposited along the bottom and sidewalls of the trenches to define the first and second metallic feature 14a, 14b. The dielectric features 7a, 7b can be deposited within the trenches over the metallic features 14a, 14b in the dies 2a, 2b and the carrier 3. The upper surface 5 of the carrier 3 and the lower surface 12 of the dies 2a, 2b can be prepared for direct bonding as explained above. For example, the upper surface 5 and the lower surface 12 can be polished to a very high surface smoothness, and can be activated and terminated with a suitable species (e.g., nitrogen). In some embodiments, the metallic features 14a, 14b may be recessed relative to the dielectric features 7a, 7b (e.g., recessed below the dielectric features 7a, 7b by less than 20 nm, or by less than 10 nm). The lower surfaces 12 of the dies 2a, 2b can be brought into contact with the upper surface 5 of the carrier 3 at room temperature to form a direct bond between at least the non-conductive field regions of the dies 2a, 2b and the carrier 3 (e.g., a direct bond between the dielectric features 7a, 7b disposed in each element). The non-conductive regions can be directly bonded without application of pressure or voltage in some arrangements. In some embodiments, the structure 1 can be heated to increase the bond strength and/or to cause the metallic features 14a, 14b to form an electrical contact with one another.

The resulting bonded structure 1 can be bonded along the interface 6, and the waveguide 10 can be defined at least in part along the bond interface 6. For example, the first and second metallic features 14a, 14b and the associated dielectric features 7a, 7b can cooperate along the interface 6 to form the first waveguide portion 10a of the waveguide 10. In particular, the first and second metallic features 14a, 14b can bond to one another such that the walls 11c, 11d can be formed from respective side portions of the features 14a, 14b (e.g., the portions of the metal that line the sidewalls of the trenches in the elements). The walls 11a, 11b can be defined by the portions of the metal that line the bottoms of the trenches in the respective elements. As shown in the side sectional view of FIG. 3B, the metallic features 14a, 14b can cooperate to define an effectively closed metallic channel (e.g., a completely closed metallic channel in the arrangement of FIG. 3B) disposed about the dielectric material 7 (which is defined by the respective dielectric features 7a, 7b). Beneficially, the direct bond between the metallic features 14a, 14b and between the dielectric features 7a, 7b can enable face down solutions (e.g., with each die's active surface facing the carrier 3) for die-to-die communications with improved electrical performance and lower losses for frequencies below 1 THz (e.g., greater than 22 GHz, or in a range of 22 GHz to 1 THz), as compared with other die-to-die interconnects.

Turning to FIG. 3C, in the illustrated embodiment, the second waveguide portion 10b can be defined along and underlying the gaps 4 between the dies 4a, 4b. In the second waveguide portion 10b, the channel 11 can be defined by the second metallic portion 14b formed in the carrier 3 and by a first metallic portion 14a that can be deposited or adhered over the second metallic portion 14b and the dielectric material 7. As with FIG. 3B, the first and second metallic portions 14a, 14b may be separately defined or integrated so as to cooperate to define the waveguide portion 10b. The second waveguide portion 10b can accordingly be embedded or buried in the carrier 3, with the upper wall 11a defined by metal applied over the upper surface 5 of the carrier 3. The height of the second waveguide portion 10b along the z-axis (see FIG. 2) can be less than the height of the first waveguide portion 10a along the z-axis, as shown in FIGS. 3B and 3C. The height differential between the first and second waveguide portions 10a, 10b may introduce some impedance discontinuities, but the overall effect on electrical performance is negligible. The width of the first and second waveguide portions 10a, 10b along the y-axis (see FIG. 2) may be substantially the same, which can ensure effective propagation along the x-axis. Beneficially, the second waveguide portion 10b can be embedded within a carrier 3, which can be a semiconductor element (such as an interposer, an integrated device die, a reconstituted die or wafer, etc.) in the illustrated embodiment.

FIGS. 4A-4C are schematic perspective views of waveguides 10 with different metallic patterns for the metallic channel 11. In particular, FIG. 4A is a schematic perspective view of a waveguide 10 which can be similar to the waveguide 10 shown in FIG. 2, prior to bonding. In FIG. 4A, for example, first metallic features 14a can include the wall 11a and metallic legs that are disposed on and/or extend from the wall 11a to at least partially define the walls 11c, 11d, and which can be provided on a first element (such as the dies 2a-2c). Second metallic features 14b can include the wall 11b and metallic legs that are disposed on and/or extend from the wall 11b to at least partially define the walls 11c, 11d, and which can be provided on a second element (such as the carrier 3). The metallic features 14a, 14b can be directly bonded to one another to define the walls 11c, 11d. In the embodiment of FIG. 4A, the metallic features 14a, 14b comprise a continuous linear metallic segments such that, when the features 14a, 14b are directly bonded to one another, the walls 11a-11d define a channel 11 that is effectively closed (e.g., completely closed) as viewed from a cross-section taken perpendicular to the propagation direction (e.g., the x-axis). Although not illustrated in FIG. 4A, it should be appreciated that corresponding dielectric features 7a, 7b (see FIG. 3B) can also be directly bonded so as to define the dielectric material 7 disposed within the metallic channel 11 defined by the walls 11a-11d. Furthermore, although the waveguide 10 shown in FIG. 4A is straight or linear, in other embodiments, the waveguide 10 can bend, turn, or curve so as to cause the waves W to follow a curved or angled pathway.

In some arrangements, it may be undesirable to provide continuous linear segments, such as the metallic features 14a, 14b shown in FIG. 4A. For example, in some cases, polishing the metallic features 14a, 14b and dielectric features 7a, 7b using processes such as chemical mechanical polishing can cause dishing along the bonding surfaces of the elements to be bonded. The dishing can cause uneven surfaces along the bonding surfaces, which may be undesirable. Thus, in some embodiments, the metallic features 14a, 14b that define the walls 11c, 11d of the channel 11 may instead be patterned to define smaller metallic features that are less susceptible to dishing.

Accordingly, FIG. 4B is a schematic perspective view of a waveguide 10 in which portions of conductive features 14a, 14b are patterned with discontinuities or gaps 15 to avoid dishing. FIG. 4C is a schematic perspective view of a waveguide 10 in which both metallic features 14a, 14b are patterned with discontinuities or gaps 15 along their lengths to avoid dishing. Unlike FIG. 4A, in FIGS. 4B and 4C, the metallic features 14a, 14b can be patterned (e.g., using lithography or by selective deposition) to have gaps 15 between the portions of the metallic feature 14a, 14b along the direction of propagation (the x-axis). In FIG. 4B, only a few small discontinuities or gaps 15 are provided, which may not affect the electrical performance of the waveguide 10. In FIG. 4C, numerous gaps 15 are provided along the length of the waveguide 10, which may slightly affect the electrical performance. However, any degradation in electrical performance for the embodiment of FIG. 4C may be negligible or eliminated if the gaps 15 are significantly smaller than the wavelength of the waves W that are coupled to the waveguide 10. Thus, even though the metallic features 14a, 14b may have gaps 15 or discontinuities, the metallic channel 11 may nevertheless be effectively closed if the gaps 15 are sufficiently small as compared with the wavelength of the waves W.

For example, the gaps 15 can be sized so as to be less than 20% (e.g., less than 15%, or less than 10%) of the wavelength of the waves W to be coupled to the waveguide 10. In some embodiments, the gaps 15 can be sized so as to be in a range of 0.5% to 15%, in a range of 1% to 10%, or in a range of 2% to 5% of the wavelength of the waves W to be coupled to the waveguide 10. Relatively small pitches for the metallic features 14a, 14b and associated gaps 15 therein can be defined using lithographic techniques. In various embodiments, for example, the pitch of the gaps 15 and metallic features 14a, 14b can be 30 microns or less for wavelengths greater than 300 microns. In various embodiments, the pitch of the gaps 15 and metallic features 14a, 14b can be less than 20 microns or less than 10 microns. In various embodiments, the pitch of the gaps 15 and metallic features 14a, 14b can be in a range of 1 micron to 40 microns, in a range of 1 micron to 30 microns, in a range of 5 microns to 30 microns, in a range of 5 microns to 20 microns, or in a range of 5 microns to 10 microns. The ability to create small pitch discontinuities or gaps in the metallic features 14a, 14b in a semiconductor element (such as a die or interposer) can beneficially reduce dishing while enabling little or no degradation in electrical performance. For waveguides 10 that are completely embedded in the semiconductor element, the pitch can be further reduced, e.g., to below 1 micron as defined by photolithographic limits.

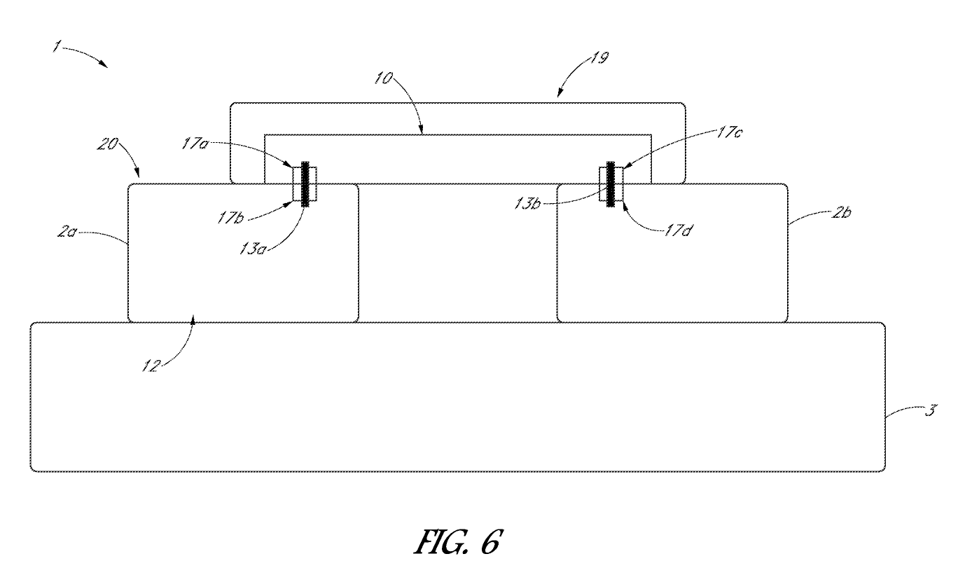

FIG. 5 is a schematic perspective view of a structure 1 with a waveguide 10 embedded in a carrier 3 comprising a semiconductor element, prior to bonding of the dies 2a, 2b to the carrier 3. In the embodiment of FIG. 5, the waveguide 10 is at least partially embedded in the carrier 3, which can comprise a semiconductor element such as an integrated device die, a semiconductor interposer, a reconstituted die or wafer, etc. In some embodiments, the waveguide 10 is completely embedded in the carrier 3 such that the walls 11a-11d of the channel 11 are buried within the carrier 3. In other embodiments, the waveguide 10 can be at least partially embedded in the carrier 3 but may have a wall 11a that is exposed at or near the upper surface 5 of the carrier 3. As with the embodiments of FIGS. 1-4C, the waveguide 10 can comprise a metallic channel 11 that defines an effectively closed metallic or conductive profile, as viewed from a side cross section taken along the direction of wave propagation. In some embodiments, the metallic channel 11 may comprise a continuous and completely closed profile, while in other embodiments, the metallic channel 11 may comprise gaps or discontinuities.

As shown in FIG. 5, the carrier 3 can comprise ports 17b, 17d, and the dies 2a-2b can comprise corresponding ports 17a, 17c. The ports 17b, 17d can extend through the effectively closed metallic channel 11 to the upper surface 5 of the carrier 3, and the ports 17a, 17c can be exposed on the lower surface 12 of the dies 2a-2b. The ports 17a-17d can be configured to couple to radiating elements 13a, 13b to transmit electromagnetic radiation to, or to receive electromagnetic radiation from, the waveguide 10. For example, the dies 2a, 2b can be aligned relative to the carrier 3 such that the port 17a generally aligns with the port 17b and the port 17c aligns with the port 17d. The dies 2a, 2b can be bonded to the carrier 3, including along the interface between the ports 17a and 17b and between the ports 17c and 17d. In the illustrated embodiment, for example, a metallic periphery 18a of the port 17a can be directly bonded to a metallic periphery 18b of the port 17b without an intervening adhesive. Similarly, a metallic periphery 18c of the port 17c can be directly bonded to a metallic periphery 18d of the port 17d. Dielectric features 7a-7d within the metallic peripheries 18a-18d can also be directly bonded to one another. In other embodiments, the metallic peripheries 18a-18d can be bonded in other ways, such as by way of a conductive adhesive or solder.

Upon bonding of the dies 2a, 2b to the carrier 3, the radiating elements 13a, 13b can electromagnetically couple to the waveguide 10 by way of the ports 17b, 17d. In the illustrated embodiment, the radiating elements 13a, 13b can comprise probes of a conductive segment that are inserted into openings in the metallic channel 11 defined by the ports 17b, 17d. In other embodiments, as explained above, the radiating elements 13a, 13b can comprise other suitable structures, such as conductive loops or apertures. Accordingly, in the embodiment shown in FIG. 5, the waveguide 10 can be at least partially embedded in the carrier 3 which can comprise a semiconductor element or other substrate material with a bonding layer (e.g., silicon oxide) having metallic features embedded therein. Bonding the dies 2a, 2b to the carrier can provide electrical communication between the dies 2a, 2b by electromagnetically coupling the dies 2a, 2b to the waveguide 10 within the carrier 3.

FIG. 6 is a schematic side view of a structure 1 comprising a bridge 19 between the dies 2a, 2b that includes an integrated waveguide 10 therein. Unless otherwise noted, the components of FIG. 6 may be the same as or generally similar to like numbered components of FIGS. 1-5. For example, in FIG. 6, the structure can comprise integrated device dies 2a, 2b bonded (e.g., directly bonded) to the carrier 3. However, unlike the embodiments of FIGS. 1-5, in FIG. 6, the bridge 19 can be bonded to the dies 2a, 2b on upper surfaces 20, which can be the active surfaces, of the dies 2a, 2b, which are opposite the lower surfaces 12 and the carrier 3. The waveguide 10 can be provided at least partially in the bridge 19 as shown in FIG. 6. In some embodiments, the waveguide 10 can be at least partially (e.g., completely) embedded in the bridge 19, similar to the manner in which the waveguide 10 is embedded in the carrier 3 as shown in FIG. 5. In other embodiments, the waveguide 10 can be defined by features along both sides of an interface between the dies 2a, 2b and the bridge 19, similar to the manner in which the waveguide 10 is defined in FIGS. 3A-3B. As with the above embodiments, the waveguide 10 can comprise a metallic channel having an effectively closed profile (e.g., completely closed or including small discontinuities or gaps) and within which a dielectric material is disposed, as viewed along a cross section taken transverse to the propagation direction. In some embodiments, the bridge 19 comprises a semiconductor element, such as an interposer, an integrated device die, etc. In some embodiments, the bridge 19 may be the waveguide itself, such that the waveguide 10 spans the gap between the dies 2a, 2b. In other embodiments, the waveguide can be provided directly across the dies, instead of embedding it in a bridge structure.

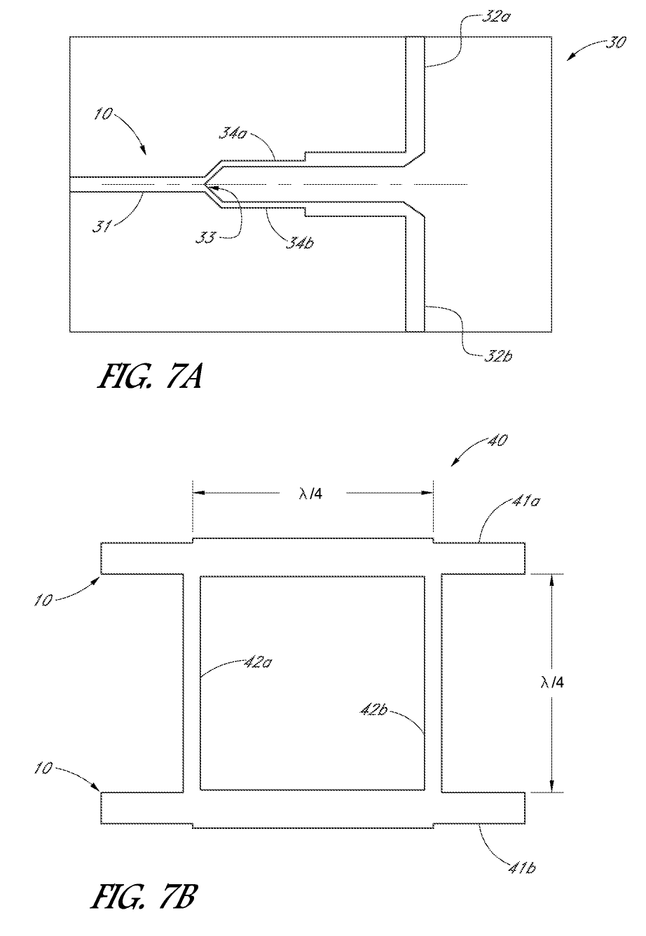

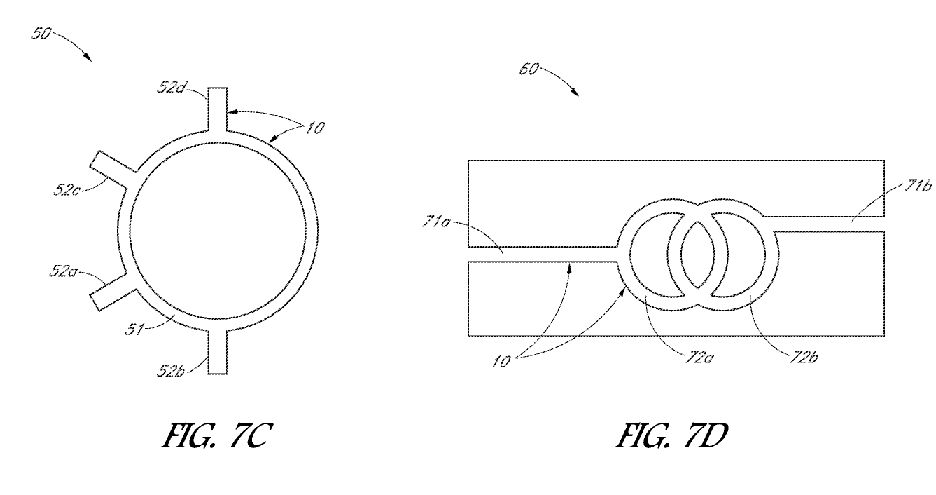

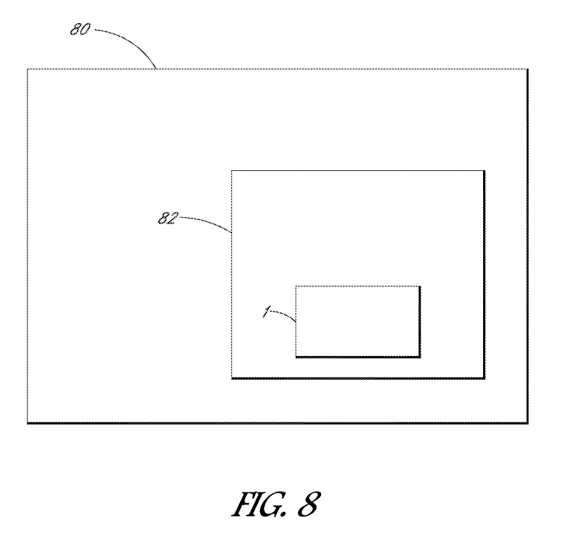

FIGS. 7A-7D illustrate various devices that can be constructed utilizing the waveguides 10 disclosed herein. As explained above, the waveguides 10 utilized in FIGS. 7A-7D can comprise effectively closed metallic channels (e.g., completely closed or with discontinuities or gaps that are small compared to the electromagnetic wavelengths to be communicated therethrough). The waveguides 10 utilized in FIGS. 7A-7D can be defined along an interface between two elements (such as between a die and a carrier, as in FIGS. 3A-3C), or can be at least partially embedded in one element (similar to the embodiment of FIG. 5). FIG. 7A is a top plan view of a power divider 30 that incorporates any of the waveguide structures 10 described above. The power divider 30 can comprise waveguide structures 10 disposed in or on an element (such as a substrate, interposer, integrated device die, etc.). The waveguide 10 can comprise a primary channel 31 that splits into a plurality of divided channels 32a, 32b at a junction 33. Divided channels 32a, 32b, 34a, and 34b can also be defined as waveguide structures similar to the waveguides 10 disclosed herein. The power divider based on the integrated waveguide structures disclosed herein may function in a manner similar to conventional planar power dividers based on microstrips or striplines. However, beneficially, the embodiments disclosed herein can provide lower losses and better performance at higher frequencies. The waveguide 10 may broaden out at the divided channels 32a, 32b. The power divider 30 can divide or split the power of the electromagnetic waves that propagate along the waveguide 10.

FIG. 7B is a top plan view of a coupler 40 that incorporates the waveguides 10 described herein. The coupler 40 can comprise one or more waveguides 10 disposed in or on an element (such as a substrate, interposer, integrated device die, etc.). The waveguide 10 can comprise first and second longitudinal arms 41a, 41b that are spaced apart from one another, e.g., by a quarter wavelength. As shown in FIG. 7B, the arms 41a, 41b can be connected by connector waveguides 42a, 42b. The connector waveguides 42a, 42b can be spaced apart from one another, e.g., by a quarter wavelength. During operation, electromagnetic waves can propagate along the longitudinal arms 41a, 41b of the waveguide 10. The waves propagating along one of the arms 41a, 41b can couple to the waves propagating along the other of the arms 41a, 41b, by propagating along the connector waveguides 42a, 42b. The coupler based on the integrated waveguide structures may function in a manner similar to a conventional planar coupler based on microstrips or striplines. However, beneficially, the embodiments disclosed herein may provide lower losses and better performance at higher frequencies.

FIG. 7C is a top plan view of a circulator 50 that incorporates the waveguides 10 described herein. The circulator 50 can comprise one or more waveguides 10 disposed in or on an element (such as a substrate, interposer, integrated device die, etc.). The circulator 50 can include a waveguide 10 having a curved or circular pathway 51. A first port 52a can act as an input for coupling electromagnetic radiation into the circular pathway 51. Second and third ports 52b, 52c can act as in-phase output ports for directing electromagnetic radiation out of the circular pathway 51. A fourth port 52d can comprise an isolated port. The circulator based on the integrated waveguide structures disclosed herein may function in a manner similar to a conventional planar circulator based on microstrips or striplines. However, beneficially, the embodiments disclosed herein may provide lower losses and better performance at higher frequencies.

FIG. 7D is a top plan view of a filter 60 that incorporates the waveguides 10 disclosed herein. The filter 60 can comprise one or more waveguides 10 disposed in or on an element (such as a substrate, interposer, integrated device die, etc.). The waveguide 10 can comprise an input line 71a and an output line 71b. A plurality of ring-shaped elements 72a, 72b can be provide between the input and output lines 71a, 71b. For example, the input line 71a can electromagnetically couple with the ring-shaped element 72a. The ring-shaped element 72a can couple with the ring-shaped element 72b, which can in turn electromagnetically couple with the output line 71b. Selected wavelength(s) of radiation propagating along the input line 71a can be filtered by the ring-shaped elements 72a, 72b, such that only the selected wavelength(s) are transmitted to the output line 71b. The filter based on the integrated waveguide structures disclosed herein may function in a manner similar to a conventional planar filter based on microstrips or striplines. However, beneficially, the embodiments disclosed herein may provide lower losses and better performance at higher frequencies.

Thus, as shown in FIGS. 7A-7D, the waveguides 10 disclosed herein in FIGS. 1-6 can be shaped in plan view in any suitable manner so as to define various components that have different electrical functionalities. The waveguides 10 may accordingly be bent, angled, or curved, as seen from a top view. Moreover, the waveguides 10 can comprise multiple components that interact with one another to define various types of devices.

FIG. 8 is a schematic system diagram of an electronic system 80 incorporating one or more structures 1, according to various embodiments. The system 80 can comprise any suitable type of electronic device, such as a mobile electronic device (e.g., a smartphone, a tablet computing device, a laptop computer, etc.), a desktop computer, an automobile or components thereof, a stereo system, a medical device, a camera, or any other suitable type of system. In some embodiments, the electronic system 80 can comprise a microprocessor, a graphics processor, an electronic recording device, or digital memory. The system 80 can include one or more device packages 82 which are mechanically and electrically connected to the system 80, e.g., by way of one or more motherboards. Each package 82 can comprise one or more structures 1. The system 80 shown in FIG. 8 can comprise any of the structures 1 shown and described herein.

In one embodiment, a structure is disclosed. The structure can include a first element and a carrier bonded to the first element along an interface. The structure can include a waveguide defined at least in part along the interface between the first element and the carrier. The waveguide can comprise an effectively closed metallic channel and a dielectric material within the effectively closed metallic channel as viewed from a side cross-section of the structure.

In another embodiment, a structure is disclosed. The structure can include a semiconductor element having a waveguide at least partially embedded therein. The waveguide can comprise an effectively closed metallic channel and a dielectric material within the effectively closed metallic channel as viewed from a side cross-section of the structure. The structure can include a first port extending through the effectively closed metallic channel to an exterior surface of the semiconductor element. The first port can be configured to couple to a radiating element to transmit electromagnetic radiation to, or to receive electromagnetic radiation from, the waveguide.

In another embodiment, a method of forming a structure is disclosed. The method can include providing a first element and a carrier. The first element can comprise first metallic features and first dielectric features exposed on an exterior surface of the first element. The carrier can comprise second metallic features and second dielectric features exposed on an exterior surface of the carrier. The method can include bonding the first element to the carrier along an interface to bond the first metallic features and the second metallic features and to bond the first dielectric features and the second dielectric features. The bonded first element and carrier can define a waveguide at least in part along the interface between the first element and the carrier. The waveguide can comprise an effectively closed metallic channel and a dielectric material within the effectively closed metallic channel as viewed from a side cross-section of the structure.

For purposes of summarizing the disclosed embodiments and the advantages achieved over the prior art, certain objects and advantages have been described herein. Of course, it is to be understood that not necessarily all such objects or advantages may be achieved in accordance with any particular embodiment. Thus, for example, those skilled in the art will recognize that the disclosed implementations may be embodied or carried out in a manner that achieves or optimizes one advantage or group of advantages as taught or suggested herein without necessarily achieving other objects or advantages as may be taught or suggested herein.

All of these embodiments are intended to be within the scope of this disclosure. These and other embodiments will become readily apparent to those skilled in the art from the following detailed description of the embodiments having reference to the attached figures, the claims not being limited to any particular embodiment(s) disclosed. Although this certain embodiments and examples have been disclosed herein, it will be understood by those skilled in the art that the disclosed implementations extend beyond the specifically disclosed embodiments to other alternative embodiments and/or uses and obvious modifications and equivalents thereof. In addition, while several variations have been shown and described in detail, other modifications will be readily apparent to those of skill in the art based upon this disclosure. It is also contemplated that various combinations or sub-combinations of the specific features and aspects of the embodiments may be made and still fall within the scope. It should be understood that various features and aspects of the disclosed embodiments can be combined with, or substituted for, one another in order to form varying modes of the disclosed implementations. Thus, it is intended that the scope of the subject matter herein disclosed should not be limited by the particular disclosed embodiments described above, but should be determined only by a fair reading of the claims that follow.

What is claimed is:

1. A structure comprising:
a first element;
a carrier bonded to the first element along an interface; and
a waveguide defined at least in part along the interface between the first element and the carrier, the waveguide comprising an effectively closed metallic channel and a dielectric material within the effectively closed metallic channel as viewed from a side cross-section of the structure.

2. The structure of claim 1, wherein the first element and the carrier are directly bonded to one another without an intervening adhesive.

3. The structure of claim 1, wherein first metallic features are defined in the first element and second metallic features are defined in the carrier, the first and second metallic features being bonded to one another to define the effectively closed metallic channel.

4. The structure of claim 3, wherein first dielectric features are defined in the first element and second dielectric features are defined in the carrier, the first and second dielectric features being bonded to one another to define the dielectric material.

5. The structure of claim 1, wherein the effectively closed metallic channel comprises gaps between portions of the metallic channel, the gaps being smaller than a wavelength of electromagnetic radiation to be propagated along the waveguide.

6. The structure of claim 5, wherein the gaps are less than 10% of the wavelength of the electromagnetic radiation.

7. The structure of claim 6, further comprising a second element bonded to the carrier along a second interface and spaced laterally from the first element, the waveguide extending from the first element to the second element and being defined at least in part along the second interface between the carrier and the second element.

8. The structure of claim 7, wherein the waveguide comprises a first waveguide portion defined by a lower surface of the first element and an upper surface of the carrier and a second waveguide portion underlying a gap between the first and second elements, wherein a height of the second waveguide portion is less than a height of the first waveguide portion.

9. The structure of claim 8, further comprising a first port extending from the first element through the metallic channel, the first port configured to couple to a first radiating element to transmit electromagnetic radiation to, or to receive electromagnetic radiation from, the waveguide.

10. The structure of claim 1, wherein the waveguide is at least partially embedded in the carrier with a wall of the metallic channel exposed at an upper surface of the carrier.

11. The structure of claim 1, wherein the carrier comprises a bridge extending between an upper surface of the first element and an upper surface a second element spaced apart from the first element, the waveguide at least partially embedded in the bridge, wherein the structure further comprises a second carrier, wherein lower surfaces of the first and second elements are bonded to the second carrier.

12. The structure of claim 1, wherein the waveguide is shaped so as to define a device comprising at least one a power divider, a coupler, a circulator, and a filter.

13. A structure comprising:
a semiconductor element having a waveguide at least partially embedded therein, the waveguide comprising an effectively closed metallic channel and a dielectric material within the effectively closed metallic channel as viewed from a side cross-section of the structure; and
a first port extending through the effectively closed metallic channel to an exterior surface of the semiconductor element, the first port configured to couple to a radiating element to transmit electromagnetic radiation to, or to receive electromagnetic radiation from, the waveguide.

14. The structure of claim 13, wherein the first port comprises a first metallic boundary, the structure further comprising a first element bonded to the semiconductor element, the first element comprising a second port having a second metallic boundary, the first and second metallic boundaries aligned with and bonded to one another.

15. The structure of claim 14, further comprising a third port having a third metallic boundary and extending through the effectively closed metallic channel to the exterior surface of the semiconductor element, and a second element bonded to the semiconductor element and laterally spaced from the first element, the second element comprising a fourth port having a fourth metallic boundary, the third and fourth metallic boundaries aligned with and bonded to one another.

16. The structure of claim 13, wherein the effectively closed metallic channel comprises a completely closed metallic channel.

17. The structure of claim 13, wherein the effectively closed metallic channel comprises gaps between portions of the metallic channel, the gaps being smaller than a wavelength of electromagnetic radiation to be propagated along the waveguide.

18. The structure of claim 13, wherein the waveguide is completely embedded in the semiconductor element.

19. A method of forming a structure, the method comprising:
providing a first element and a carrier, wherein the first element comprises first metallic features and first dielectric features exposed on an exterior surface of the first element and the carrier comprises second metallic features and second dielectric features exposed on an exterior surface of the carrier;
bonding the first element to the carrier along an interface to bond the first metallic features and the second metallic features and to bond the first dielectric features and the second dielectric features, the bonded first element and carrier defining a waveguide at least in part along the interface between the first element and the carrier, the waveguide comprising an effectively closed metallic channel and a dielectric material within the effectively closed metallic channel as viewed from a side cross-section of the structure.

20. The method of claim 19, wherein bonding comprises directly bonding the first element to the carrier without an intervening adhesive.
